(19) United States
(12) Patent Application Publication
(10) Pub. No.: US 2023/0371699 A1
(43) Pub. Date: Nov. 23, 2023

(54) TRANSVERSE ROD ASSEMBLY OF IRON BED FRAME

(71) Applicant: Luhao LENG, Xiamen City (CN)

(72) Inventor: Luhao LENG, Xiamen City (CN)

(21) Appl. No.: 17/967,966

(22) Filed: Oct. 18, 2022

(30) Foreign Application Priority Data
May 19, 2022 (CN) 202221206588.2

(51) Int. Cl. A47C 19/00; F16B 12/56

(52) U.S. Cl. CPC A47C 19/005; F16B 12/56

(57) ABSTRACT

A transverse rod assembly of an iron bed frame comprises two transverse rods, two supporting feet, and a linking rod. A top end of each of the two supporting feet is disposed with a connecting seat, and the connecting seat is connected with a corresponding one of the two transverse rods. Each of the two transverse rods comprises two transverse rod units configured to be spliced together. Inner ends of the two transverse rod units are pivotally connected to the connecting seat so that each of the two transverse rods is configured to be folded in half using a corresponding one of the two supporting feet as a center line. The linking rod is connected between the two supporting feet to pull the two supporting feet in a longitudinal direction. End portions of the linking rod are detachably insertion-connected to the two supporting feet

### RELATED APPLICATIONS

This application claims priority to Chinese patent application number 202221206588.2, filed on May 19, 2022. Chinese patent application number 202221206588.2 is incorporated herein by reference.

### FIELD OF THE DISCLOSURE

The present disclosure relates to a transverse rod assembly of an iron bed frame.

### BACKGROUND OF THE DISCLOSURE

An iron bed frame refers to a supporting frame of the iron frame bed, which comprises two transverse bars, two longitudinal bars, and four bed feet. A length of each of the two transverse bars is longer than a length of each of the two longitudinal bars, such that especially when a user sits on a middle position of the two transverse bars, a distance between a point of bearing weight and the four bed feet is the longest. In order to improve strength of the two transverse bars, an effective method is to add a supporting foot below the middle position of the two transverse bars. The supporting foot can be directly locked on the two transverse bars. In other techniques, a rod sleeve is also set on the supporting foot to be connected to the two transverse bars. However, in daily use, consumers may easily kick the supporting feet, and the supporting feet can be kicked crookedly with a small force, causing the supporting feet to not provide a good support and even causing the two transverse bars to twist. In addition, due to the large length of the two transverse bars, packaging and transportation are inconvenient.

### BRIEF SUMMARY OF THE DISCLOSURE

The present disclosure provides a transverse rod assembly of an iron bed frame, which has better stability and is convenient for packaging and transportation. A technical solution of the present disclosure is as follows.

A transverse rod assembly of an iron bed frame comprises two transverse rods symmetrically in parallel to each other, two supporting feet, and a linking rod. The two supporting feet are matched with the two transverse rods in a one-to-one correspondence. The two supporting feet are located below a middle position of the two transverse rods. A top end of each of the two supporting feet is disposed with a connecting seat, and the connecting seat is connected with a corresponding one of the two transverse rods. Each of the two transverse rods comprises two transverse rod units configured to be spliced together. Inner ends of the two transverse rod units are pivotally connected to the connecting seat so that each of the two transverse rods is configured to be folded in half using a corresponding one of the two supporting feet as a center line. The linking rod is connected between the two supporting feet to pull the two supporting feet in a longitudinal direction. End portions of the linking rod are detachably insertion-connected to the two supporting feet.

The two transverse rod units are pivotally connected with the connecting seat at the top end of one of the two supporting feet, so that the two transverse rods can be folded, which is convenient for packaging and transportation. At the same time, after the two transverse rods are unfolded, the two supporting feet are located in the middle position of the two transverse rods, which can improve a supporting capacity of the two transverse rods. The two supporting feet on the two transverse rods are connected by the linking rod, a distance between the two supporting feet remains fixed, and the two supporting feet and the linking rod form an H-shaped bracket structure, which improves stability of the two supporting feet and makes the two supporting feet have good resistance to deformation and impact.

In a preferred embodiment, end surfaces of the linking rod comprise U-shaped steel grooves corresponding to the two supporting feet, and the U-shaped steel grooves are configured to be clamped to the two supporting feet, which has a firm structure.

In a preferred embodiment, one or more tongue pieces protrude from a bottom surface of each of the U-shaped steel grooves, each of the two supporting feet comprises one or more buckle openings, and the one or more tongue pieces are configured to be inserted into the one or more buckle openings.

In a preferred embodiment, an upper edge of each of the one or more tongue pieces is connected to the bottom surface of each of the U-shaped steel grooves, and the one or more tongue pieces are configured to be inserted into lower edges of the one or more buckle openings due to gravity. That is, the one or more tongue pieces cooperate with the one or more buckle openings to achieve a buckling-and-hooking connection between the U-shaped steel grooves and the two supporting feet. Therefore, the distance between the two supporting feet cannot be reduced due to existence of the linking rod, and because of the one or more tongue pieces and the one or more buckle openings, the distance between the two supporting feet cannot be enlarged. That is, the linking rod can pull the two supporting feet in the longitudinal direction to ensure that the two supporting feet cannot be inclined due to a big impact.

In a preferred embodiment, the one or more tongue pieces are two tongue pieces spaced apart from each other in an up-to-down direction, and the one or more buckle openings are two buckle openings spaced apart from each other in the up-to-down direction.

In a preferred embodiment, the connecting seat comprises a seat plate and two side plates. The seat plate is connected to a top surface of the corresponding one of the two supporting feet. The two side plates are symmetrically connected to two sides of the seat plate. A part of the two side plates extending out of the seat plate is pivotally connected with the two transverse rod units. Each of the two supporting feet is disposed between the two transverse rod units when the two transverse rods are folded. A length of the two side plates is longer than a length of the seat plate, and the part of the two side plates extending out of the seat plate is pivotally connected with the two transverse rod units. This structure can better enable the two transverse rod units to be folded using the corresponding one of the two supporting feet as the center line and make the two transverse rods neater after being folded.

In a preferred embodiment, an outer end surface of each of the two transverse rod units is connected with a locking piece, and the locking piece comprises one or more bolt holes. The locking piece is convenient for connections of other components of the iron bed frame, such as a column and a bed foot.

In a preferred embodiment, an inner side of each of the two transverse rod units is disposed with a buckle member for supporting a bed beam bar. The buckle member is convenient for supporting the bed beam bar of the iron bed frame.

In a preferred embodiment, an inner surface of the buckle member comprises a positioning protrusion. The positioning protrusion can be connected to the bed beam bar in a quickly spliced and position-limiting manner.

### BRIEF DESCRIPTION OF THE DRAWINGS

FIG. 1 illustrates a perspective view of a transverse rod assembly.

FIG. 2 illustrates an exploded view of the transverse rod assembly in FIG. 1.

FIG. 3 illustrates a perspective view of one of two transverse rods of the transverse rod assembly in a folded state in FIG. 1.

FIG. 4 illustrates an enlarged perspective view of a linking rod of the transverse rod assembly in FIG. 1.

FIG. 5 illustrates an enlarged perspective view of one of two supporting feet of the transverse rod assembly in FIG. 1.

FIG. 6 illustrates a perspective view of an iron bed frame using the transverse rod assembly in FIG. 1.

### DETAILED DESCRIPTION OF THE EMBODIMENTS

The present disclosure will be further described below in combination with the accompanying drawings and embodiments.

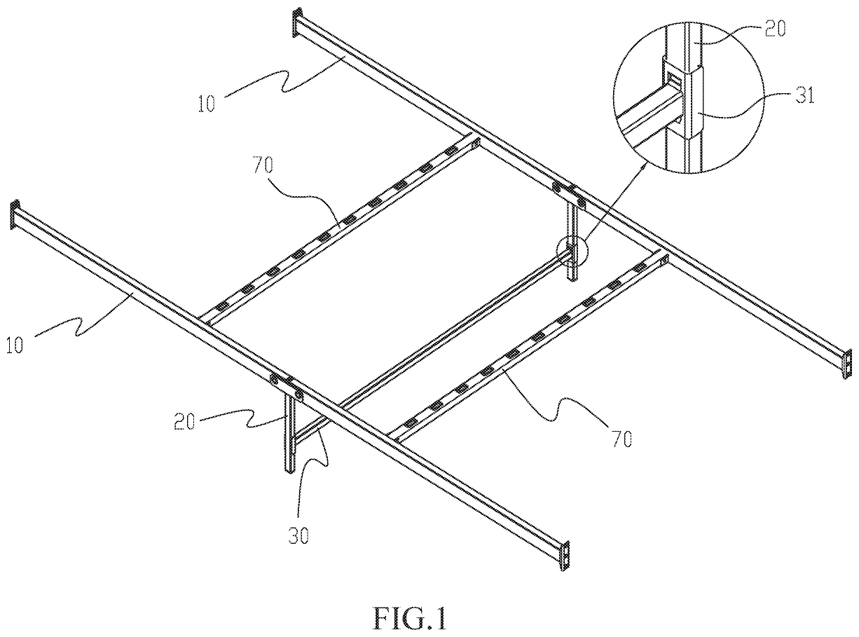

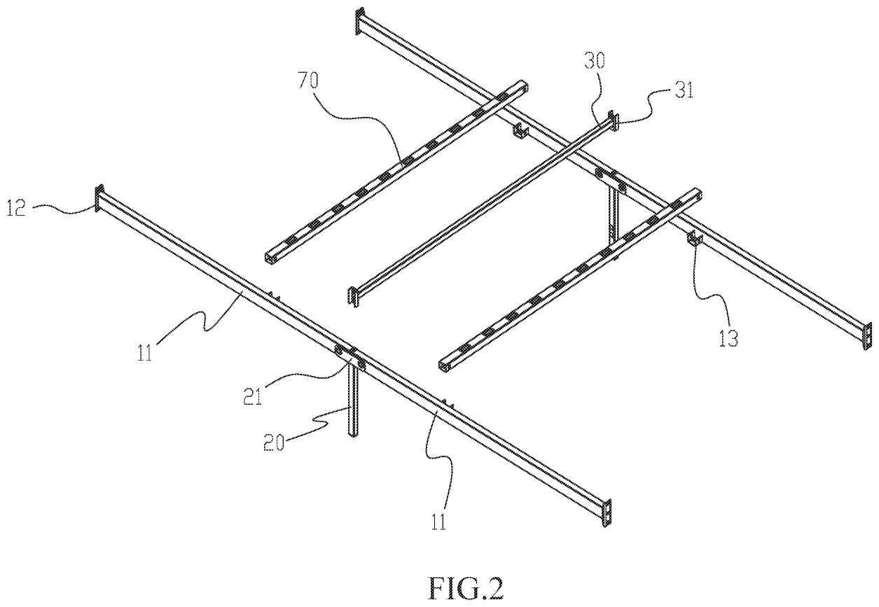

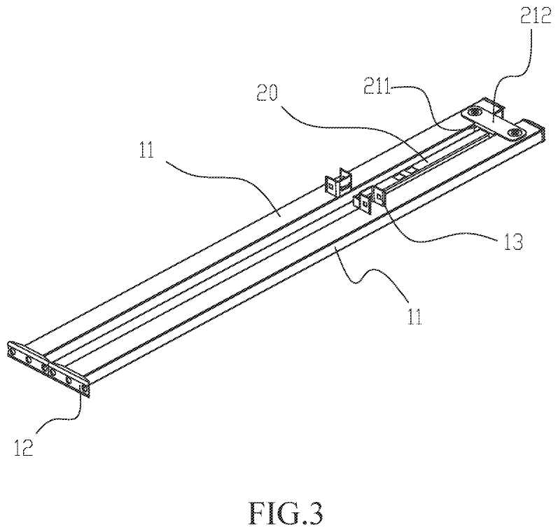

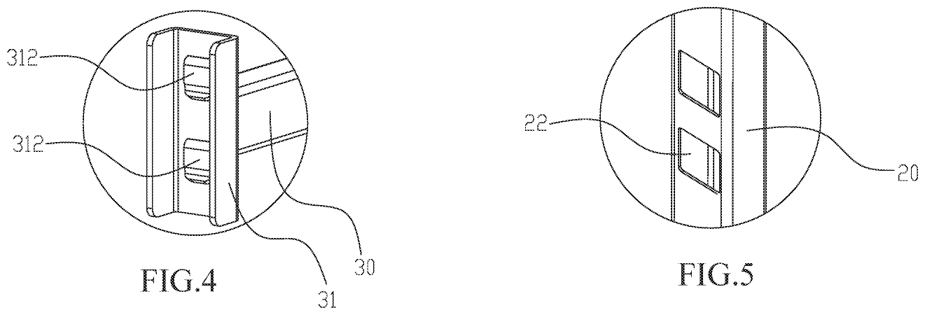

Referring to FIGS. 1 to 6, a transverse rod assembly of an iron bed frame comprises two transverse rods 10 arranged symmetrically parallel to each other and two supporting feet 20. The two supporting feet 20 are matched with the two transverse rods 10 in a one-to-one correspondence. The two supporting feet 20 are located below a middle position of the two transverse rods 10. A top end of each of the two supporting feet 20 is disposed with a connecting seat 21, and the connecting seat 21 is connected with a corresponding one of the two transverse rods 10. The two transverse rods 10 can be folded. Specifically, each of the two transverse rods 10 comprises two transverse rod units 11 spliced together, and inner ends (i.e., adjacent sides) of the two transverse rod units 11 are pivotally connected to the connecting seat 21, so that each of the two transverse rods 10 can be folded in half using a corresponding one of the two supporting feet 20 as a center line (as shown in FIG. 3). The transverse rod assembly further comprises a linking rod 30 arranged horizontally in a longitudinal direction. The linking rod 30 is connected between the two supporting feet 20 to pull the two supporting feet 20 in the longitudinal direction. End portions of the linking rod 30 are detachably insertion-connected to the two supporting feet 20. The linking rod 30 pulls the two supporting feet 20 in the longitudinal direction, not only to hold the two supporting feet 20 to prevent them from approaching each other, but also to hold the two supporting feet 20 to prevent them from being separated from each other. That is, a distance between the two supporting feet 20 is unchanged.

Preferably, end surfaces of the linking rod 30 comprise U-shaped steel grooves 31 corresponding to the two supporting feet 20, and the U-shaped steel grooves 31 are clamped to the two supporting feet 20.

Preferably, one or more tongue pieces 312 protrude from a bottom surface of each of the U-shaped steel grooves 31, and each of the two supporting feet 20 comprises one or more buckle openings 22. The one or more tongue pieces 312 are inserted into the one or more buckle openings 22. Further preferably, an upper edge of each of the one or more tongue pieces 312 is connected to the bottom surface of each of the U-shaped steel grooves 31, and the one or more tongue pieces 312 are inserted into lower edges of the one or more buckle openings 22 due to gravity, so that the one or more tongue pieces 312 can pull the two supporting feet 20. In this embodiment, the one or more tongue pieces 312 in each of the U-shaped steel grooves 31 are two tongue pieces 312 spaced apart from each other in an up-to-down direction, and the one or more buckle openings 22 on each of the two supporting feet 20 are two buckle openings 22 spaced apart from each other in the up-to-down direction.

Preferably, the connecting seat 21 comprises a seat plate 211 and two side plates 212. The seat plate 211 is connected to a top surface of the corresponding one of the two supporting feet 20. The two side plates 212 are symmetrically connected to two sides of the seat plate 211. A part of the two side plates 212 extending out of the seat plate 211 is pivotally connected with the two transverse rod units 11. Each of the two supporting feet 20 is disposed between the two transverse rod units 11 when the two transverse rods 10 are folded. The two side plates 212 are longer than the seat plate 211, so that the two transverse rod units 11 can be rotated and folded toward the corresponding one of the two supporting feet 20, so that the corresponding one of the two supporting feet 20 is disposed between the two transverse rod units 11.

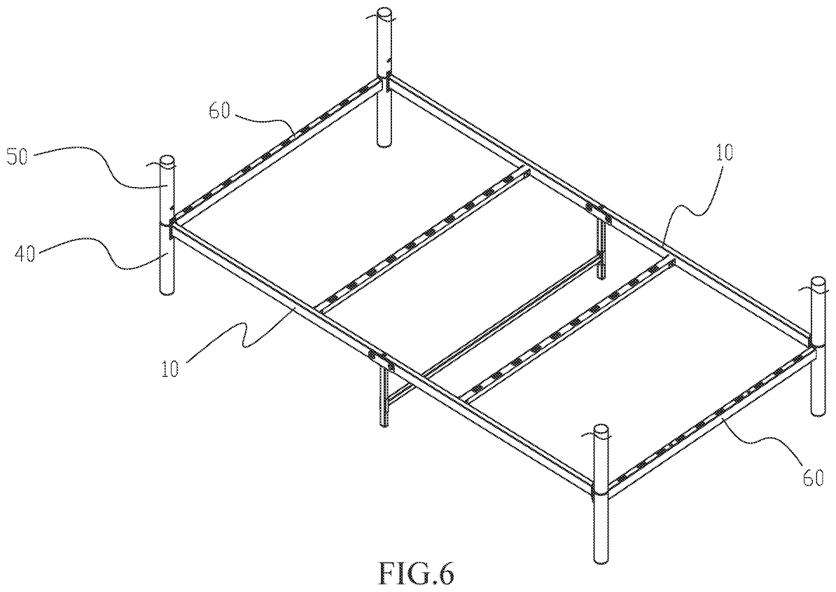

Preferably, an outer end surface of each of the two transverse rod units 11 is connected with a locking piece 12, and the locking piece 12 comprises one or more bolt holes. In the iron bed frame shown in FIG. 6, the locking piece 12 is locked with a bed foot 40 and an upright column 50, and a longitudinal rod 60 of the iron bed frame can be disposed between two of the bed feet 40 on a same side.

Preferably, an inner side of each of the two transverse rod units 11 is disposed with a buckle member 13 for supporting a bed beam bar 70. The bed beam bar 70 is disposed between the two transverse rods 10, which can strengthen overall stability of the transverse rod assembly. In particular, when an inner surface of the buckle member 13 comprises a positioning protrusion, the positioning protrusion is buckle-connected with the bed beam bar 70, and the bed beam bar 70 can also pull the two transverse rods 10 in the longitudinal direction to further improve stability of the entire frame.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A transverse rod assembly of an iron bed frame, comprising:
two transverse rods symmetrically in parallel to each other,
two supporting feet, and
a linking rod, wherein:
the two supporting feet are matched with the two transverse rods in a one-to-one correspondence,
the two supporting feet are located below a middle position of the two transverse rods,
a top end of each of the two supporting feet is disposed with a connecting seat,
the connecting seat is connected with a corresponding one of the two transverse rods,
each of the two transverse rods comprises two transverse rod units configured to be spliced together,
inner ends of the two transverse rod units are pivotally connected to the connecting seat so that each of the two transverse rods is configured to be folded in half using a corresponding one of the two supporting feet as a center line,
the linking rod is connected between the two supporting feet to pull the two supporting feet in a longitudinal direction, and
end portions of the linking rod are detachably insertion-connected to the two supporting feet.

2. The transverse rod assembly of the iron bed frame according to claim 1, wherein:
end surfaces of the linking rod comprise U-shaped steel grooves corresponding to the two supporting feet, and
the U-shaped steel grooves are configured to be clamped to the two supporting feet.

3. The transverse rod assembly of the iron bed frame according to claim 2, wherein:
one or more tongue pieces protrude from a bottom surface of each of the U-shaped steel grooves,
each of the two supporting feet comprises one or more buckle openings, and
the one or more tongue pieces are configured to be inserted into the one or more buckle openings.

4. The transverse rod assembly of the iron bed frame according to claim 3, wherein:
an upper edge of each of the one or more tongue pieces is connected to the bottom surface of each of the U-shaped steel grooves, and
the one or more tongue pieces are configured to be inserted into lower edges of the one or more buckle openings due to gravity.

5. The transverse rod assembly of the iron bed frame according to claim 4, wherein:
the one or more tongue pieces are two tongue pieces spaced apart from each other in an up-to-down direction, and
the one or more buckle openings are two buckle openings spaced apart from each other in the up-to-down direction.

6. The transverse rod assembly of the iron bed frame according to claim 1, wherein:
the connecting seat comprises a seat plate and two side plates,
the seat plate is connected to a top surface of the corresponding one of the two supporting feet,
the two side plates are symmetrically connected to two sides of the seat plate,
a part of the two side plates extending out of the seat plate is pivotally connected with the two transverse rod units, and
each of the two supporting feet is disposed between the two transverse rod units when the two transverse rods are folded.

7. The transverse rod assembly of the iron bed frame according to claim 1, wherein:
an outer end surface of each of the two transverse rod units is connected with a locking piece, and
the locking piece comprises one or more bolt holes.

8. The transverse rod assembly of the iron bed frame according to claim 1, wherein:
an inner side of each of the two transverse rod units is disposed with a buckle member for supporting a bed beam bar.

9. The transverse rod assembly of the iron bed frame according to claim 8, wherein:
an inner surface of the buckle member comprises a positioning protrusion.
